(19) United States
(12) Patent Application Publication
(10) Pub. No.: US 2006/0193263 A1
(43) Pub. Date: Aug. 31, 2006

(54) Method and system to simulate delays in geographically distributed computing environments

(75) Inventors: Thothathri Vanamamalai, Redmond, WA (US); Karan Mehra, Redmond, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/066,077

(22) Filed: Feb. 25, 2005

(51) Int. Cl. H04J 1/16; H04L 12/26

(52) U.S. Cl. 370/241

(57) ABSTRACT

Systems and methods are described for implementing a delay driver within a cluster service storage stack, which delay driver simulates the latency experienced between two nodes in geographically distant locations. The delay driver determines whether I/O request packets should be delayed, selects the number and types of I/O requests packets to be delayed and the amount of time to delay processing of the packets. Through the use of such a driver, a user is able to simulate various conditions that geoclusters may experience when separated over large distances.

### FIELD OF THE INVENTION

This invention relates generally to geographically distributed computing environments, and more particularly, to simulating the communication delays that occur in processing I/O packets in server cluster nodes spread across a large geographical distance.

### BACKGROUND OF THE INVENTION

A primary goal for many businesses today is the delivery of increased server availability, improved network services and dependable redundancy capabilities in the event of hardware and software failures. Many organizations are also seeking to consolidate their infrastructure by eliminating the replication of servers and repeated applications.

One solution that achieves these goals is a server cluster. Clusters are defined as a set of nodes that together, provide a highly available and highly scalable platform for hosting applications. Server clusters provide a managed clustering architecture that keeps server-based applications highly available, regardless of individual component failures. Cluster technologies such as Microsoft Cluster Server (MSCS) and Network Load Balancing (NLB) provide redundancy to enable applications or services to continue automatically either through failover of the application or by having multiple instances of the same application available for client requests.

A basic cluster design consists of a group of independent computers that work together to run a common set of applications, such as Microsoft SQL Server. Clusters appear to be a single system to the client and the application, but are actually comprised of multiple servers. The servers are physically connected by network and storage infrastructure and logically connected by the cluster service software.

FIG. 1 illustrates a geographically dispersed cluster arrangement, also known as geospan clusters or, more simply, geoclusters. Geoclusters may span a distance ranging from between a few hundred to few thousand kilometers, and may be used for disaster recovery. Each server in the cluster is termed a “node.” A geographically dispersed cluster is a cluster that has the following attributes: multiple storage arrays, at least one deployed at each site; nodes connected to storage in such a way that, in the event of a failure of a site or the communication links between sites, the nodes on a given site can access the storage on that site; and host-based software that provides a way to mirror or replicate data between the sites so that each site has a copy of the data.

In the example of FIG. 1, nodes 1 and 2 are located at first site and connected to each other via a network 5. Nodes 3 and 4 are located at a second site and are likewise locally connected via a network 6. The two sites are geographically dispersed. For example, the first site may be located in the Los Angeles area and the second in the New York area. The nodes and storage of the two sites are further coupled together by an appropriate network, schematically illustrated at reference numeral 7. Typically, the private and public network connections between cluster nodes must appear as a single, non-routed LAN. It is necessary when implementing geoclusters, therefore, to use technologies such as VLANs to ensure that all nodes in the cluster appear on the same IP subnets.

Continuing the example of FIG. 1, nodes 1 and 2 are connected to a storage controller array 8, and nodes 3 and 4 are connected to a second storage controller array 9. The storage arrays communicate and present a single view of the disks spanning both arrays. Disks 10-13 are thus combined into a single logical device. Individual data stores, such as disks 10 and 11, are mirrored across the cluster, as indicated by cloud 14. Likewise, disks 12 and 13 are mirrored across the cluster, as indicated by cloud 15. The cluster may thus failover between any of the nodes 1-4 and any of the data stores 10-13. The cluster illustrated in FIG. 1 is unaware of the geographic distance between its nodes, and is implemented at the network and storage levels within the infrastructure architecture.

From time to time, the cluster software cannot differentiate between an actual failure of one or more nodes and a failure of such nodes to adequately communicate. In this situation, one or more nodes (and applications running thereon) may begin to operate independently of the others, each of which having determined that the other node or nodes have failed. When this occurs, the cluster is said to have a “split-brain.” A split-brain scenario happens, for example, when all of the network communication links between two or more cluster nodes fail. In such a situation, the cluster may be split into multiple partitions that cannot communicate. Each node continues to operate under the assumption that the other node or nodes have failed, thereby increasing the likelihood of corrupting data on one or more data stores.

A split-brain scenario may occur in a single-site cluster deployment, but is much more likely to occur in a geographically dispersed configuration. This is due in large part to the propagation delays of packets, known as “heartbeat packets,” that are used to detect whether a node is alive or not responding. These packets are sent out on a periodic basis, known as a heartbeat interval. If a node takes too long to respond to heartbeat packets, the cluster service starts a protocol to determine which nodes are really still alive and which ones are non-functional. This process is known as a cluster regroup.

Empirical research has determined that heartbeat intervals exceeding 1.2 seconds can substantially diminish the stability of the cluster. Given this constraint, system designers have established a related constraint, namely, that all nodes provide a maximum guaranteed round trip latency of no more than 500 milliseconds. A 500 millisecond round-trip is significantly below any threshold to ensure that artificial regroup operations are not triggered.

Propagation delay, even for signals traveling at the speed of light, can thus affect the stability of a cluster. Theoretically, a packet traveling at the speed of light in the most direct manner possible between Los Angeles and New York (approximately 4000 km), e.g., through a single dedicated fiber optic channel, will experience a 13.3 millisecond propagation delay in each direction and a roundtrip propagation of at least 26.6 milliseconds. This theoretical minimum, however, is unachievable due to the presence of multiple switches between such locations, each of which introduces substantial additional delay. In practice, studies have shown that latencies range from between 4 milliseconds for a 100 kilometer separation to 150 milliseconds for a 3700 kilometer separation in a geocluster implementation. Propagation of each heartbeat packet can thus consume more than half of the available time to respond to a heartbeat.

The network and storage architectures used to build geographically dispersed clusters, however, must preserve the semantics that the server cluster technology expects. Stated alternatively, this means that the clusters must behave as if the distance betweens nodes was insignificant.

It is therefore necessary for developers of cluster software to insure that the latency of various operations, including input/output (“I/O”) storage operations, is within the bounds required to support applications. In other words, it is necessary to be able to verify that the time to accomplish a certain operation between geographically distant servers, when added to the communication time to propagate a response, do not exceed a given latency threshold, such as 500 milliseconds.

It is also necessary for those who implement cluster servers to test a particular geocluster in a single location before physically deploying the clusters across vast geographical distances. By testing the configuration in a single location prior to dispersing the nodes across different locations, the cluster implementing team may be able to more efficiently identify and resolve system problems than if such problems were first identified in different (and physically distant) locations. This is because the expertise and resources to identify and resolve such problems can be concentrated in a single location. Once the configuration has been proven to work in a single location, the clusters may then be separated.

FIG. 2 illustrates the prior art approach of testing applications and configurations of cluster nodes at a single site. As illustrated in this figure, a physical cable 202 is placed between a cluster node 200 and storage 201. The length of the cable 202 is equal to, or exceeds, the intended distance between two cluster servers once deployed. Through use of this “test” cable or cables, two or more nodes and/or storage can thus be placed in a single location for development and testing purposes.

This prior art “solution,” i.e., test cables, is undesirable for a variety of reasons, including the high costs of cable, the inconvenience of introducing a physical cable into the test environment, the relative lack of flexibility in changing the test environment, the burden of having to store and maintain the cable, and the like. It is thus desirable to create a less cumbersome and more efficient means to simulate the delay associated with I/O packets traveling across geographically dispersed cluster nodes.

### BRIEF SUMMARY OF THE INVENTION

The problems outlined above may at least in part be addressed by a system and method, implemented in software, that simulates the delay experienced by nodes in transmitting and receiving packets in a geographically dispersed computing environment, such as a cluster server environment.

The following presents a simplified summary of the disclosure in order to provide a basic understanding to the reader. This summary is not an exhaustive or limiting overview of the disclosure. The summary is not provided to identify key and, or critical elements of the invention, delineate the scope of the invention, or limit the scope of the invention in any way. Its sole purpose is to present some of the concepts disclosed in a simplified form, as an introduction to the more detailed description that is presented later.

In one embodiment of the invention, the system and method intercepts packets within a queue in a geocluster node prior to transmission to a physical or logical storage device. Transmission of the interrupted packets is delayed for a predetermined period of time. The delay period corresponds to the amount of time estimated for a packet to traverse a certain distance.

In a highly preferred embodiment of the invention, the inventive system and method intercepts packets that are entering a queue. The processing queue may be a transmission control queue or any queue in which packets are processed. For example, the queue of interest may be the queue used by the Microsoft Windows kernel I/O manager to process Input/Output request packets (“IRPs”) relating to storage. In this embodiment, a new logical driver, an I/O delay driver, is deployed between the cluster disk service and the drivers on each node in the cluster. The I/O delay driver determines whether a delay has been enabled, and, if so, intercepts IRPs destined for the device drivers and then delays these packets for a preset period of time. If a delay has not been enabled, the I/O delay driver passes the IRP to the I/O queue without further delay.

An embodiment of the invention is implemented through a computer-readable medium of computer-executable instructions that instantiate an I/O delay driver. The medium includes instructions to check whether a flag has been set to delay the packets. If the flag has been set, the computer-executable instructions cause the computer to intercept packets destined for the I/O queue and to delay the passage of such packets.

In yet another embodiment, the inventive system and method selectively intercepts packets within a queue in a geocluster node prior to transmission of such packets to a physical or logical storage device. In this embodiment, certain packets will be transmitted without delay while others will be transmitted after a predetermined delay. In a highly preferred example of this embodiment, an I/O delay driver intercepts packets within an IRP processing queue and then selectively determines which IRPs within the queue to delay. The determination of the packets to be delayed is made, for example, by reference to a file name, an originating process or a disk partition. In a further refinement of this embodiment, the I/O driver selects every Nth IRP of a certain type for delay.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a simplified schematic illustrating an exemplary architecture of a geographically dispersed cluster server computing environment, as used in accordance with an embodiment of the invention;

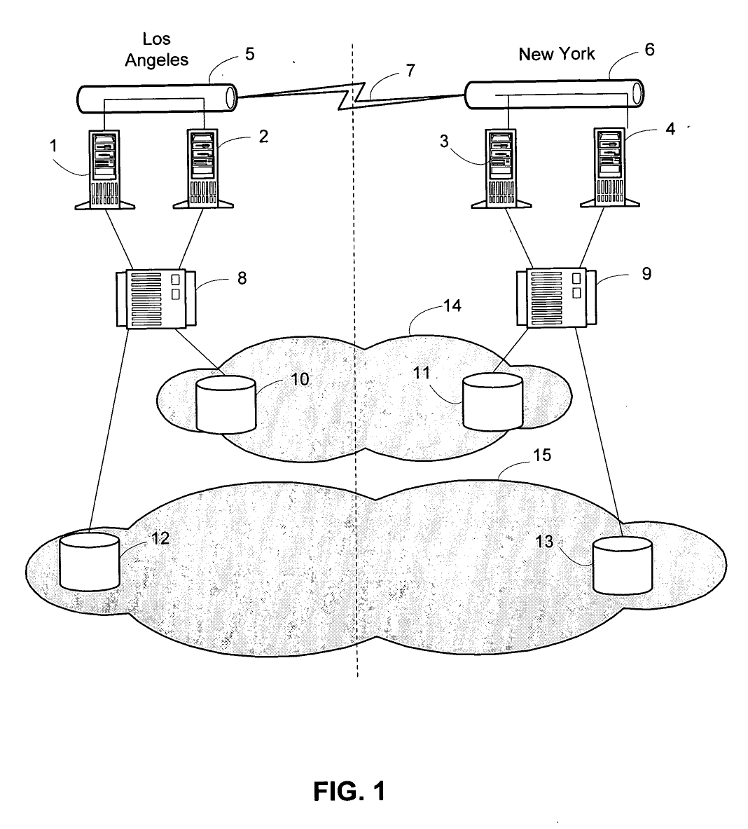

FIG. 2 is a schematic diagram illustrating the prior art approach to simulating delays in a geocluster server;

FIG. 3 is a simplified schematic illustrating an exemplary architecture of a computer, as used in accordance with an embodiment of the invention;

FIG. 4 is a diagram schematically illustrating the I/O process of an exemplary computer;

FIG. 5 is a diagram schematically illustrating a cluster service stack for processing I/O request packets in accordance with an embodiment of the invention; and

FIG. 6 is a flow diagram illustrating the steps of an I/O delay driver in accordance with an embodiment of the invention.

### DETAILED DESCRIPTION OF THE INVENTION

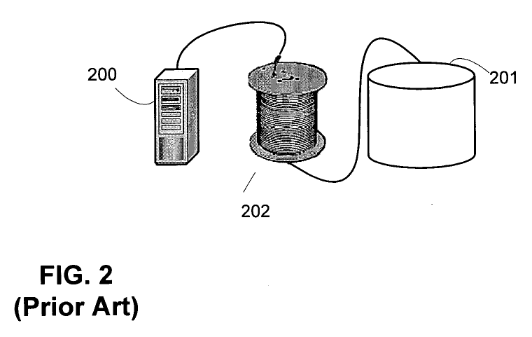

As discussed in the background, there is a need to simulate the latency of geoclusters in a single site environment. As illustrated in FIG. 2, the prior art approach to addressing this need involved placing a physical cable between a source and a destination wherein the length of the cable was equal to, or exceeded, the desired distance between the nodes once implemented. This prior art approach was costly, inefficient and inflexible.

The methods and systems to simulate the delay associated with packets transmitted between geoclusters, particularly I/O request packets (“IRPs”), will now be described with respect to preferred embodiments; however, the methods and systems of the present invention are not so limited. Moreover, the skilled artisan will readily appreciate that the methods and systems described herein are merely exemplary and that variations can be made without departing from the spirit and scope of the invention. After reviewing this description, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method operations or system elements, it should be understood that those operations and those elements may be combined in other ways to accomplish the same objectives. Operations, elements, and features discussed only in connection with one embodiment are not intended to be excluded from a similar role in other embodiments. Moreover, use of ordinal terms such as “first” and “second” in the claims to modify a claim element does not by itself connote any priority, precedence, or order of one claim element over another or the temporal order in which operations of a method are performed, but are used merely as labels to distinguish one claim element having a certain name from another element having a same name (but for use of the ordinal term) to distinguish the claim elements.

The invention is illustrated as being implemented in a suitable computing environment. Although not required, the invention will be described in the general context of computer-executable instructions, such as procedures, being executed by a personal computer. Generally, procedures include program modules, routines, functions, programs, objects, components, data structures, etc. that perform particular tasks or implement particular abstract data types. Moreover, those skilled in the art will appreciate that the invention may be practiced in a variety of computer system configurations, including hand-held devices, multi-processor systems, and microprocessor-based or programmable consumer electronics devices. The invention may also be practiced in distributed computing environments where tasks are performed by remote processing devices that are linked through a communications network. In a distributed computing environment, program modules may be located in both local and remote memory storage devices. The term computer system may be used to refer to a system of computers such as may be found in a distributed computing environment.

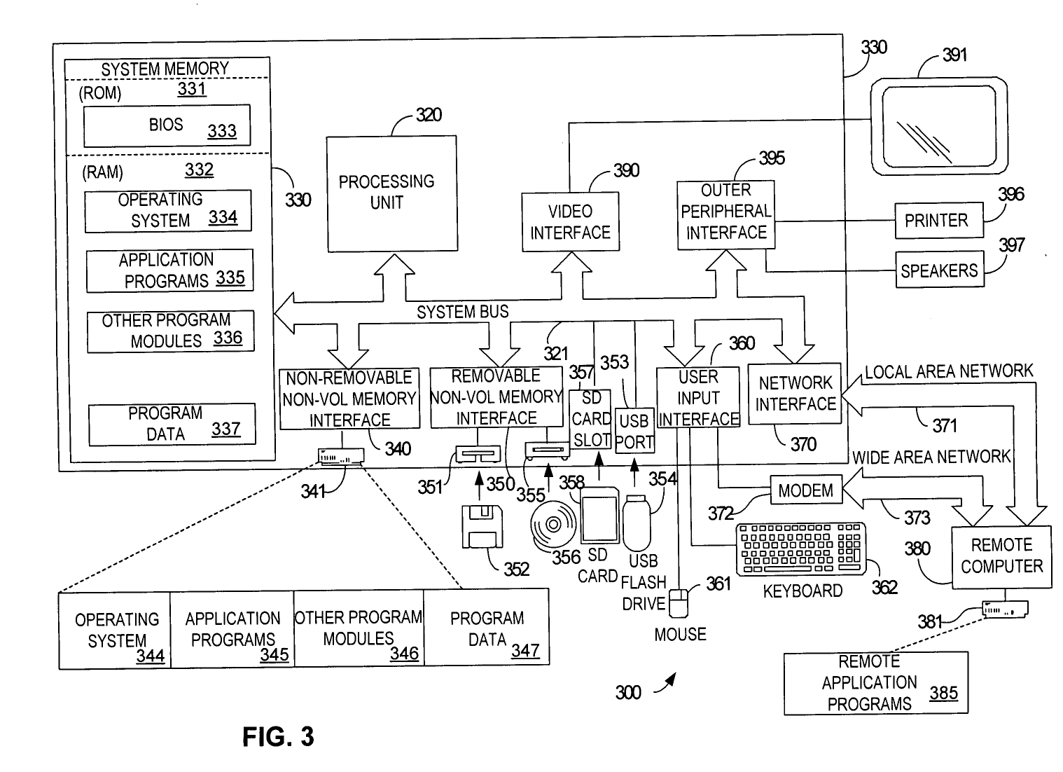

FIG. 3 illustrates an example of a suitable computing system environment 300 in which the invention may be implemented. The computing system environment 300 is only one example of a suitable computing environment and is not intended to suggest any limitation as to the scope of use or functionality of the invention. Nor should the computing environment 300 be interpreted as having any dependency or requirement relating to any one or combination of components illustrated in the exemplary operating environment 300. Although at least one embodiment of the invention does include each component illustrated in the exemplary operating environment 300, another more typical embodiment of the invention excludes some or all non-essential components, for example, input/output devices other than those required for network communications.

That said, one example system for implementing the invention includes a general purpose computing device in the form of a computer 310. Components of the computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures.

The computer 310 typically includes a variety of computer-readable media. Computer-readable media can be any available media that can be accessed by the computer 310 and include both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, optical disk storage, magnetic cassettes, magnetic tape, magnetic disk storage or other magnetic storage devices, or any other medium which can be used to store the desired information and which can be accessed by the computer 310. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above are included within the scope of computer-readable media.

The system memory 330 includes computer storage media in the form of volatile and/or nonvolatile memory such as read only memory (ROM) 331 and random access memory (RAM) 332. By way of example, and not limitation, FIG. 3 illustrates operating system 334, application programs 335, other program modules 336 and program data 337.

The computer 310 may also include other removable and non-removable, volatile and nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CDROM. Other computer storage media that can be used in the exemplary operating environment include, but are not limited to, magnetic tape cassettes, flash memory cards, DVDs, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The computer system may include interfaces for additional types of removable non-volatile storage devices. For instance, the computer may have a USB port 353 that can accept a USB flash drive (UFD) 354, or a SD card slot 357 that can accept a Secure Digital (SD) memory card 358. A USB flash drive is a flash memory device that is fitted with a USB connector that can be inserted into a USB port on various computing devices. A SD memory card is a stamp-sized flash memory device. Both the USB flash drive and SD card offer high storage capacity in a small package and high data transfer rates. Other types of removable storage media may also be used for implementing the invention.

The drives and their associated computer storage media, discussed above and illustrated in FIG. 3, provide storage of computer-readable instructions, data structures, program modules and other data for the computer 310. In FIG. 3, for example, hard disk drive 341 is illustrated as storing an operating system 344, application programs 345, other program modules 346 and program data 347. Note that these components can either be the same as or different from operating system 334, application programs 335, other program modules 336, and program data 337. Operating system 344, application programs 345, other program modules 346, and program data 347 are given different numbers herein to illustrate that, at a minimum, they are different copies. A user may enter commands and information into the computer 310 through input devices such as a tablet, or electronic digitizer, 364, a microphone 363, a keyboard 362 and pointing device 361, commonly referred to as a mouse, trackball or touch pad. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 by way of an interface, such as a video interface 390. The monitor 391 may also be integrated with a touch-screen panel or the like. Note that the monitor and/or touch screen panel can be physically coupled to a housing in which the computing device 310 is incorporated, such as in a tablet-type personal computer. In addition, computers such as the computing device 310 may also include other peripheral output devices such as speakers 397 and printer 396, which may be connected through an output peripheral interface 394 or the like.

The computer 310 preferably operates or is adaptable to operate in a networked environment using logical connections to one or more remote computers, such as a remote computer 380. The remote computer 380 may be a personal computer, a server, a router, a peer device or other network node, and typically includes some or all of the elements described above relative to the computer 310, although only a memory storage device 381 has been illustrated in FIG. 3. The logical connections depicted in FIG. 3 include a LAN 371 and a WAN 373, but may also include other networks. For example, in the present invention, the computer 310 may comprise the source machine from which data is being migrated, and the remote computer 380 may comprise the destination machine, e.g., a thin client device. Note however that source and destination machines need not be initially connected by a network or otherwise, but instead, data may be migrated by way of any media capable of being written by the source platform and read by the destination platform or platforms. For example, one non-limiting instance of such a medium is a portable flash memory medium.

When used in a LAN environment, the computer 310 is connectable to the LAN 371 through a network interface or adapter 370. The computer 310 may also include a modem 372 or other means for establishing communications over the WAN 373. The modem 372, which may be internal or external, may be connected to the system bus 321 by way of the user input interface 360 or other appropriate mechanism. In a networked environment, program modules depicted relative to the computer 310, or portions thereof, may be stored in the remote memory storage device. By way of example, and not limitation, FIG. 3 illustrates remote application programs 385 as residing on memory device 381. It will be appreciated that the network connections shown are exemplary and other means of establishing a communications link between the computers may be used.

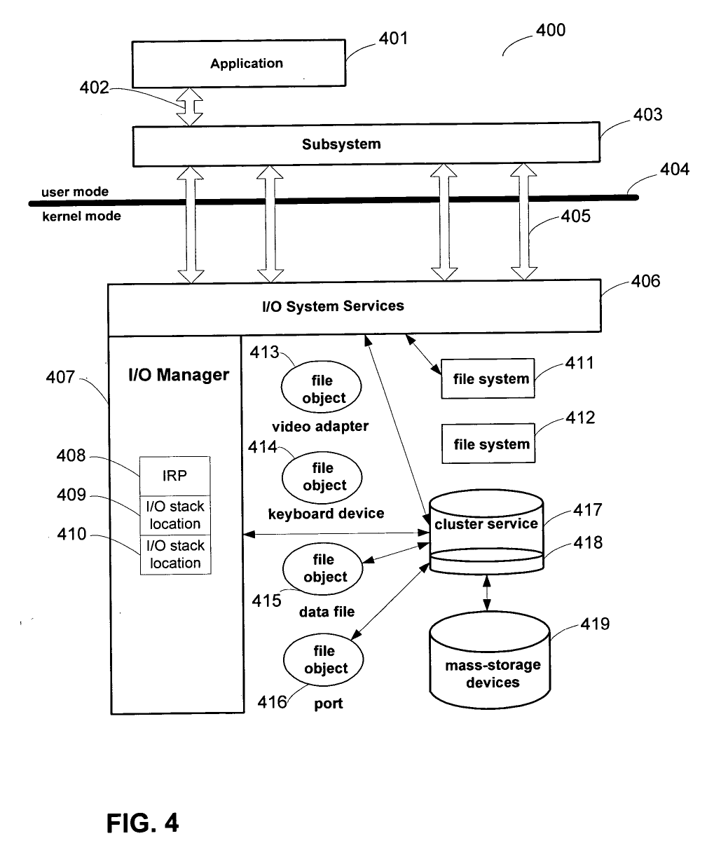

FIG. 4 schematically illustrates the components and modules that may be used to process I/O requests in an exemplary computer. The entire process is indicated by reference numeral 400. A protected subsystem 403, such as the Win32® subsystem, passes I/O requests to an appropriate kernel-mode driver through the I/O system services 406. The subsystem 403 depends on support from the display, video adapter, keyboard, and mouse device drivers.

Protected subsystem 403 insulates end users and applications, such as application 401, from having to know anything about kernel-mode components, including drivers. In turn, kernel-mode components, such as I/O manager 407, insulate protected subsystems from having to know anything about machine-specific device configurations or driver implementations.

I/O manager 407 supplies drivers with a single I/O model, a set of kernel-mode support routines that drivers can use to carry out I/O operations, and a consistent interface between the originator of an I/O request and the drivers that must respond to it.

The subsystem 403 and its native applications, such as application 401, can access a driver's device or a file on a mass-storage device only through file object handles supplied by the I/O manager 407. To open such a file object or to obtain a handle for I/O to a device or a data file, subsystem 403 calls the I/O system services 403 with a request to open a named file. The named file can have a subsystem-specific alias (symbolic link) to the kernel-mode name for the file object. I/O manager 407 locates or creates the file object that represents the device or data file and for locating the appropriate driver(s). Examples of I/O requests include read/write requests, device I/O control requests and close requests.

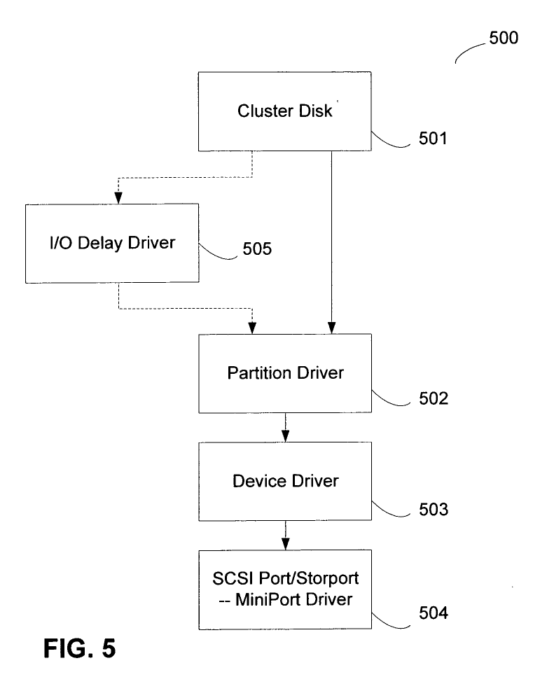

As indicated in FIG. 4, file objects may include physical devices such as a video adapter 413, a keyboard device 414, or port 416, and may also include logical information, such as a data file 415. I/O manager 407 and I/O system services 406 communicate with file objects and file systems, such as systems 411 and 412, and a cluster service 417 to further manage data. Cluster service 417, which includes various components 418, is described below in connection with FIG. 5. I/O system services 406 may also communicate, directly or indirectly, with mass-storage devices, as indicated by reference numeral 419.

The interaction between the various components illustrated in FIG. 4 is best described through an example. It is assumed in the following description that subsystem 403 has issued an “open” request for a particular file object.

In order to process the I/O request, the subsystem 403 calls an I/O system service 406 to open the named file. I/O manager 407 calls an object manager (not shown) to look up the named file and help it resolve any symbolic links for the file object. It also may call a security reference monitor (also not shown) to check that the subsystem has the correct access rights to open that file object.

If the volume is not yet mounted, I/O manager 407 suspends the open request temporarily and calls one or more file systems, e.g., 411 or 412, or a cluster service 417, until one of them recognizes the file object as something it has stored on one of the mass-storage devices the file system uses. When the file system has mounted the volume, I/O manager 407 resumes the request.

I/O manager 407 allocates memory for and initializes an I/O request packet (“IRP”) 408 for the open request. To drivers, an open is equivalent to a “create” request. I/O manager 407 thereafter calls the file system driver, passing it the IRP 408. The file system driver accesses its I/O stack location in the IRP 408, such as location 409, to determine what operation it must carry out, checks parameters, determines if the requested file is in cache, and, if not, sets up the next-lower driver's I/O stack location in the IRP 408, such as location 410. Both drivers process the IRP 408 and complete the requested I/O operation, calling kernel-mode support routines supplied by the I/O manager 407 and by other system components. The drivers return the IRP 408 to the I/O manager 407 with the I/O status block set in the IRP 408 to indicate whether the requested operation succeeded or why it failed.

The I/O manager 408 thereafter gets the I/O status from the IRP 408, so it can return status information through the protected subsystem 403 to the original caller. The I/O manager 407 subsequently frees the completed IRP 408 and returns a handle for the file object to the subsystem 403 if the open operation was successful. If there was an error, it returns appropriate status to the subsystem.

After a subsystem 403 successfully opens a file object that represents a data file, a device, or a volume, the subsystem uses the returned handle to identify the file object in subsequent requests for device I/O operations (usually read, write, or device I/O control requests). To make such a request, the subsystem calls I/O system services. The I/O manager routes these requests as IRPs sent to appropriate drivers.

The foregoing description of an example I/O process assumed only a single IRP 408. In practice, multiple IRPs may be pending and are maintained in an I/O queue. I/O requests to a device can come in faster than its driver can process them to completion, particularly in multiprocessor machines. Consequently, IRPs bound to any particular device must be queued in its driver when its device is already busy processing another IRP. Moreover, when processing a particular IRP, a driver can break an original request into smaller requests (possibly for more than one device driver) by calling an I/O support routine one or more times in order to allocate yet additional IRPs.

As will be appreciated by persons of skill in the art, the drivers that process a single IRP can be layered. One driver may call another to recursively decompose the IRP until a base driver level is reached. Each driver communicates the success or failure of a requested I/O operation in the I/O status block of an IRP, such as IRP 408. The I/O manager 407, in turn communicates the success or failure of a requested I/O operation to a user-mode requester. Each I/O driver must include an internal IRP queuing and dequeuing mechanism, which the driver uses to manage IRPs that come in faster than it can satisfy them.

Cluster service 417 may be conceptualized as a kernel-mode driver. FIG. 5 illustrates a simplified cluster service storage stack for processing IRPs directed to the cluster service. FIG. 5 further illustrates the location of an I/O delay driver 505, which implements a preferred embodiment of the invention, within the cluster service storage stack.

Cluster service storage stack 500 includes a cluster disk driver 501, which communicates with a partition driver 502, a device driver 503, and a SCSI Port/Storport—MiniPort driver 504. Each of these drivers processes IRPs as may set in an IRP queue. An embodiment of the present invention uses the storage stack of the cluster service to implement, via an I/O delay driver 505, a delay in processing IRPs that simulates latency delay. The cluster service storage stack 500 may be implemented in a conventional manner or with an I/O delay driver 505. The optional delay driver is indicated with dashed lines.

The I/O delay driver includes three separate I/O controls, also known as IOCTLs: a first IOCTL enables the delay driver; a second IOCTL sets a delay period, and a third IOCTL disables the driver.

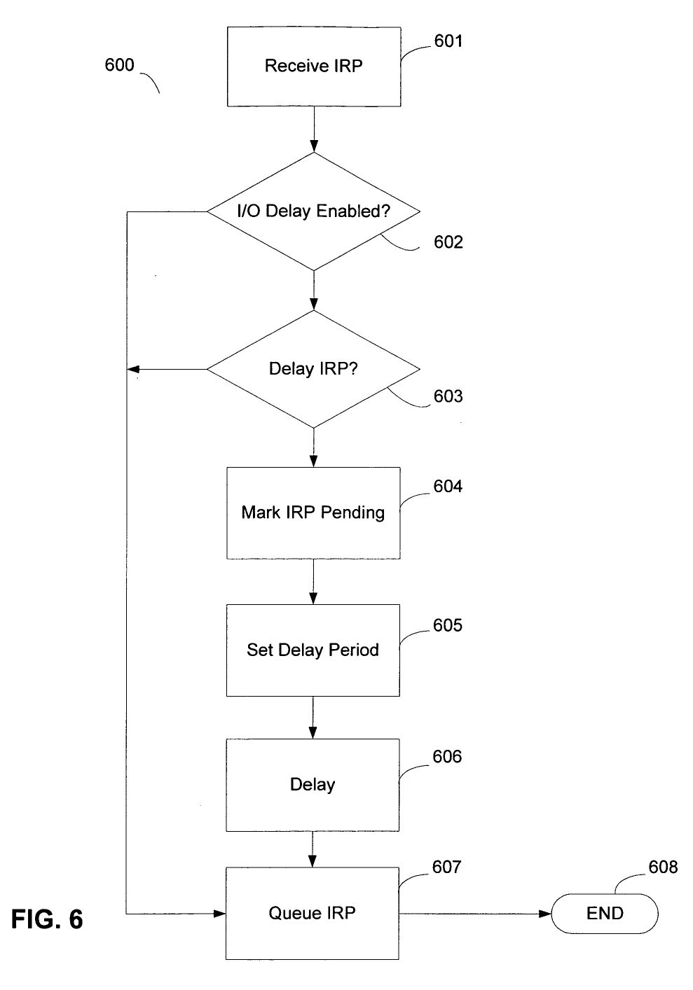

FIG. 6 illustrates the steps 600 used by delay driver 505 to simulate latency in geoclusters. At step 601, the delay driver receives an IRP for processing from the cluster driver IRP queue. The delay driver thereafter checks to determine whether a delay to simulate latency is desired. If a latency delay is not desired, the delay driver queues the IRP for additional processing, step 607. If a latency delay is desired, the delay driver subsequently determines whether the particular IRP at issue should be delayed, step 603.

In one embodiment of the invention, all IRPs processed by the cluster service storage stack are delayed when the driver has been enabled. In another embodiment, only selected IRPs are targeted for delay. In this latter embodiment, the I/O delay driver selectively determines the IRPs within a processing queue to delay. The determination of the packets to be delayed is made, for example, by reference to a file name, an originating process or a disk partition. In a further refinement of this embodiment, the I/O driver selects every N^{th} IRP for delay. Thus, every 4^{th} IRP, for example, may be delayed, while the remaining IRPs are processed without delay.

For those IRPs to be delayed, the status of the IRP within the I/O manager is marked as “pending,” step 604. Delay driver 505 thereafter sets a kernel time with an appropriate delay period, preferably ranging from 50 milliseconds to 500 milliseconds, and delays further processing of the IRP, step 606. At the expiration of the timer, delayed IRPs are subsequently passed to the IRP queue, where they are processed in order.

In view of the many possible embodiments to which the principles of the present invention may be applied, it should be recognized that the embodiments described herein with respect to the drawing figures are meant to be illustrative only and should not be taken as limiting the scope of the invention. For example, those of skill in the art will recognize that the illustrated embodiments can be modified in arrangement and detail without departing from the spirit of the invention. Although the invention is described in terms of software modules or components, those skilled in the art will recognize that such may be equivalently replaced by hardware components. Therefore, the invention as described herein contemplates all such embodiments as may come within the scope of the following claims and equivalents thereof.

What is claimed is:

1. A method for simulating propagation delay, the method comprising the steps of:
intercepting input/output request packets (IRPs) intended for processing within a queue;
delaying processing of predetermined IRPs for a predetermined period of time; and
requeuing the predetermined IRPs for processing after the predetermined period of time has elapsed.

2. The method of claim 1, wherein the predetermined period of time represents the delay associated with propagating a signal through a physical cable.

3. The method of claim 1, wherein queue processes IRPs transmitted from a geocluster and destined for a storage device.

4. The method of claim 3, wherein the storage device is a logical device.

5. The method of claim 3, wherein the storage device is a physical device.

6. The method of claim 1, wherein the predetermined IRPs are comprised of a set of IRPs of a single type.

7. The method of claim 1, wherein the predetermined IRPs are comprised of a set of every Nth packet sent to the queue.

8. The method of claim 7, wherein every Nth packet is every 3rd packet.

9. A method of processing data packets, the method comprising the steps of:
estimating the propagation time associated with transmitting an input/output request packet (IRP) from a geocluster to a physically distant storage device;
establishing a queue for processing IRPs, wherein the queue operates in a plurality of modes;
delaying predetermined IRPs for a delay period in a first mode of queue operation; and
processing the predetermined IRPs without a delay in a second mode of queue operation.

10. The method of claim 9, wherein the delayed IRPs are processed according to the second mode of operation at the conclusion of the delay period.

11. The method of claim 9, wherein the delay period represents the propagation time.

12. The method of claim 9, further comprising the step of setting a flag to determine the mode of queue operation.

13. The method of claim 9, further comprising the step of marking each delayed IRP as pending during the delay period.

14. The method of claim 9, wherein the step of delaying predetermined IRPs is accomplished through the use of a timer.

15. The method of claim 9, wherein the storage device is a logical device.

16. The method of claim 9, wherein a first Input/Output Control (“IOCTL”) enables the queue's first mode of operation, a second IOCTL sets the delay period, and a third IOCTL disables the queue's first mode of operation.

17. A computer-readable medium having computer-executable instructions for performing steps for processing data packets, comprising:
selectively intercepting input/output request packets (IRPs) intended for processing within a queue;
delaying processing of selected IRPs for a predetermined period of time; and
processing the selected IRPs after the predetermined period of time has elapsed.

18. The computer-readable medium as in claim 17, wherein the predetermined period of time represents the delay associated with propagating a signal through a physical cable.

19. The computer-readable medium as in claim 17, wherein the queue processes IRPs transmitted from a geocluster and destined for a storage device.

20. The computer-readable medium as in claim 17, wherein no IRPs are selectively intercepted.
